(19) United States
(12) Patent Application Publication
(10) Pub. No.: US 2001/0033707 A1
(43) Pub. Date: Oct. 25, 2001

(54) System and method for optically switching/routing optical channels of any wavelength to any fiber

(76) Inventor: C. Kumar N Patel, Los Angeles, CA (US)

Correspondence Address: FENWICK & WEST LLP, TWO PALO ALTO SQUARE, PALO ALTO, CA, 94306, US

(21) Appl. No.: 09/771,259

(22) Filed: Jan. 26, 2001

Related U.S. Application Data
(60) Provisional application No. 60/178,023, filed on Jan. 26, 2000.
(60) Provisional application No. 60/182,289, filed on Feb. 14, 2000.
(60) Provisional application No. 60/209,524, filed on Jun. 5, 2000.
(60) Provisional application No. 60/215,804, filed on Jul. 5, 2000.

(51) Int. Cl. G02B 6/26

(52) U.S. Cl. 385/16; 385/15

(57) ABSTRACT

An optical router switches any of the input optical channels to and from any recipient in response to digital control signal. The optical router enables relaying the optical channels in an assembly of micro-mechanical units. The input optical channels are directed to output optical fiber at predetermined positions in response to the digital control signal.

### RELATED APPLICATIONS

This application claims priority to U.S. provisional patent application Ser. No. 60/215,804, filed on Jul. 5, 2000, attorney reference number 5185, U.S. provisional application Ser. No. 60/209,524, filed on Jun. 5, 2000, attorney reference number 5008, U.S. provisional application Ser. No. 60/182,289, filed on Feb. 14, 2000, attorney reference number 4782, and U.S. Provisional application Ser. No. 60/178,023, filed on Jan. 26, 2000, attorney reference number 4729 which are all incorporated by reference herein in their entirety.

### BACKGROUND OF THE INVENTION

1. Field of the Invention

This invention relates generally to optical router technology, and more particularly, to optically routing or switching input optical signals of any wavelengths to any recipient.

2. Description of Background Art

The newly emerging optical routing technology opens another era of communications networking because of its unparallel capacity and speed in transmitting data over the optical fiber networks. An optical network, backboned by optical routers and optical switches, can deliver a vast amount of information unimpeded by the bottlenecks of conventional transport systems at significantly lower cost than previous systems.

One proposed optical router uses an array of microscopic mirrors, each of which tilts in various directions, to switch optical signals to and from any of 256 input/output optical fibers. As illustrated in FIG. 25, in the proposed optical router, the mirrors a, b, c rotate at different angles 1 and 2 in order to reflect the incoming light wave λ₁ to the one of the many outgoing fibers. In FIG. 25 only two of the outgoing fibers are shown, m₁ and m₂. The problem associated with the proposed solution is that the optical switching system has to precisely control the tilting positions of the microscopic mirror a, b, c via analog control signals to ensure the input light wave is reflected at a designated angle on the mirrors and then received by the corresponding output fiber. For example, the mirror a rotates to the position 1 and the mirror b rotates to the position 3 in order to reflect the incoming light λ₁ into the output fiber m₁; to switch the same light beam λ₁ to the output fiber m₂, the mirror a needs to switch to the position 2 and the mirror c has to be in the position 4. The precise control of the reflection angles on the microscopic mirrors demands a micro-mechanical mechanism to accurately and effectively adjust the positions of the mirrors in response to analog control signals during the routing process. As the number of switched ports increases, e.g., as the number of output fibers increases, such precise control of each reflecting mirror positions becomes increasingly more difficult and it is very likely to cause micro-mechanical positioning errors, unacceptable cross-talk and the eventual optical transmission system failure.

Moreover, in the aforementioned proposal, the microscopic mirrors that are used to reflect the light beams are flat mirrors, as shown by the mirrors a, b and c in FIG. 25. When multiple optical channels are processed in the switching system, i.e., a high density of reflection occurs on a plurality of flat mirrors, it is difficult to prevent cross-talk among the different channels because of the Rayleigh length of the free space propagating radiation that leads to increasing beam size as the light beam propagates over increasingly longer distances.

Another limitation and deficiency of the aforementioned design is its heavy reliance on switching the microscopic mirrors. In order that these microscopic mirrors rotate at fast speed to each designated angle to reflect light beams, high manufacturing cost and complicated control mechanism become unavoidable and thus set limits upon the capacity and speed of the optical router or optical switch.

Therefore, what is needed is a system and method for optically routing or switching signals having multiple wavelengths to any of intended recipients. The optical router or switch shall be capable of relaying the input optical signals and directing them to output fibers using digital control means. The optical router or switch shall have a mechanism to prevent the cross-talk among the switched optical channels. Further, the architecture of the optical or switch should make it easy to manufacture and maintain.

### SUMMARY OF THE INVENTION

The present invention is a system and method for optically routing and switching data transmission within a communications network.

In one embodiment of the present invention, an optical router includes two dimensional arrays of micro-mechanical mirrors, each mirror capable of moving between two positions, i.e., moving from a normal position to a deflecting position in response to a digital control signal to switch an input optical wavelength to an output optical fiber. A separate optical control wavelength channel, λ_{c}, (or a control signal on one of the n signal channels) carries a control signal that can be configured to switch the mirrors to the deflecting positions. A significant advantage of the optical router in accordance with the present invention is to switch a number, n, of wavelength division multiplexed optical channels entering on a single fiber to any one of intended recipients, m, without converting each of the λ_{1 . . . n} channels into electronic levels. Another advantage of the optical router in accordance with the present invention is to avoid switching the micro-mechanical mirrors to many different positions in order to improve the routing capability, reliability, and speed. The invention further includes wavelength multiplexer and demultiplexer which are coupled to both the input end and the output end. The use of the multiplexer and demultiplexer not only maintains a fall bi-directionality for routing optical channels, but also enables the optical router to send any one, several, or all of the optical signals λ_{1 . . . n}, to any of the intended users.

In another embodiment of the present invention, an optical router comprises a solid-state device with electrically controlled piezoelectric drivers mounted on each of the output optical fibers. The optical router couples the input light wave to the output fiber by activating the piezoelectric drivers in order to move the output fibers to approximate the solid-state device within a coupling distance.

In another embodiment of the present invention, an optical router comprises a solid-state device with electro-optic gratings. The optical router couples the input optical signals to the output fibers through the control of the electro-optic gratings to change the direction of the light wave which bounces back and forth within the quartz device.

In another embodiment of the present invention, an optical router switches the input optical signals by activating electrical field upon the electro-optic gratings on mirrors to change their optical characteristics in order to route the optical signals into desired output optical fibers.

These and other features and advantages of the present invention may be better understood by considering the following detailed description of the preferred or alternate embodiments of the invention. In the course the description, reference will frequently be made to the attached drawings.

### BRIEF DESCRIPTION OF THE DRAWINGS

FIG. 1 is an illustration of overall architecture of an all-optical router.

FIG. 2 is an illustration of one micro-mechanical mirror in accordance with one aspect of the invention.

FIG. 3 is an illustration of one embodiment of the present invention switching one input channel to any of the output channels.

FIG. 4 is an illustration of one embodiment of the present invention switching one input channel to one output channel.

FIG. 5 is an illustration of a two dimensional configuration of n wavelength signals switched to m users in accordance with one aspect of the present invention.

FIG. 6 is an illustration of a two dimensional configuration of n wavelength signals switched to m users with an optical combiner in accordance with one aspect of the present invention.

FIG. 7 illustrates an all-optical combiner for routing one input optical channel to a user in accordance with one aspect of the present invention.

FIG. 8 illustrates an all-optical combiner showing switching of one input channel to the output channel in accordance with one aspect of the present invention.

FIG. 9 is a two dimensional schematic illustration of a single MEMS switch for optical routing in accordance with one embodiment of the present invention.

FIG. 10 illustrates an all-optical router with curved fixed mirrors for confocal relaying of radiation in accordance with one aspect of the present invention.

FIG. 11 illustrates an optical switch that permits any wavelength to be sent to any user regardless of any other wavelengths received by that user.

FIG. 12 illustrates a four-wavelength Multiplexer/Demultiplexer for input and output from the optical switch shown in FIG. 11.

FIG. 13 illustrates the operation of the Input/Output Multiplexer/Demultiplexer showing the separation of λ₁, λ₂, λ₃ and λ₄ signals and coupling each wavelength into the respective MEMS rows.

FIG. 14 is an illustration of USER 1 Multiplexer/Demultiplexer operation showing the transmission of switched signals to user 1 in accordance with one aspect of the present invention.

FIG. 15 is an illustration of the operation of the USER 2 Multiplexer/Demultiplexer for transmitting switched signal to user 2 in accordance with one aspect of the present invention.

FIG. 16 illustrates the operation of the USER 3 Multiplexer/Demultiplexer for transmitting switched signal to user 3 in accordance with one aspect of the present invention.

FIG. 17 illustrates another embodiment of the present invention wherein preferred drivers are mounted on output optical fibers.

FIG. 18 illustrates one example of using the preferred driver mounted on one output optical fiber activated to couple the input optical radiation into the output optical fiber in accordance with one aspect of the present invention.

FIG. 19 illustrates using the preferred driver mounted on another output optical fiber activated to couple the input optical radiation into the output optical fiber.

FIG. 20 illustrates another example of using the preferred driver mounted on one output optical fiber and activated to couple the input optical radiation into the output optical fiber in accordance with one aspect of the present invention.

FIG. 21 shows using preferred reflectors for confocal relaying of the radiation within one embodiment in accordance with the present invention.

FIG. 22 illustrates another embodiment in accordance with the present invention using electrically switchable gratings for coupling the radiation into output optical fibers.

FIG. 23 illustrates the operation of the electrically switchable gratings in coupling the radiation to one user.

FIG. 24 illustrates another embodiment in accordance with the present invention using electrically switchable gratings on mirrors to deflect radiation into output fibers.

FIG. 25 is a schematic illustration of a conventional technique to optically switch optical signals into different recipient optical fibers.

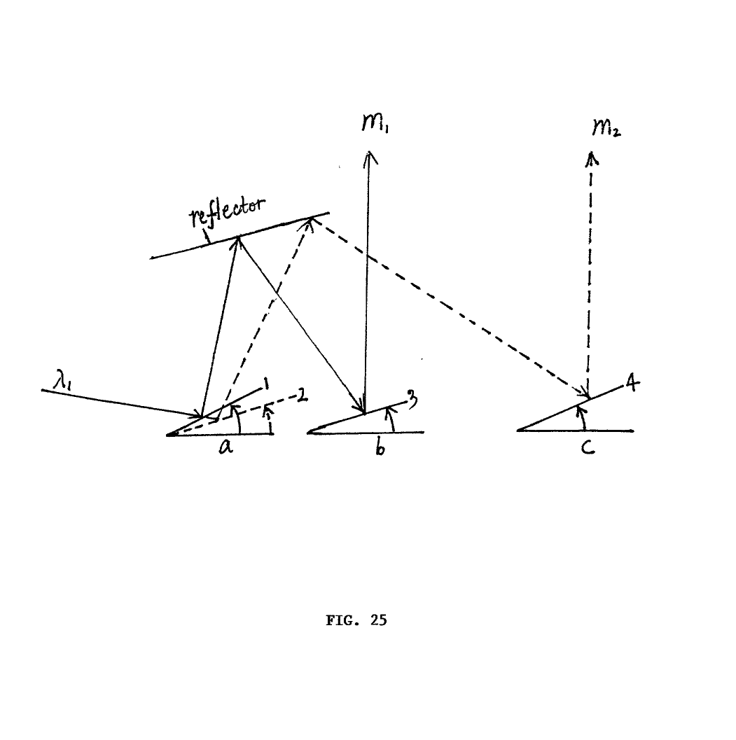

### DETAILED DESCRIPTION OF THE PREFERRED EMBODIMENTS

A preferred embodiment and alternate embodiments of the present invention are now described with reference to the figures where like reference numbers indicate identical or functionally similar elements. Also in the figures, the left most digit(s) of each reference number corresponds to the figures in which the reference number is first used.

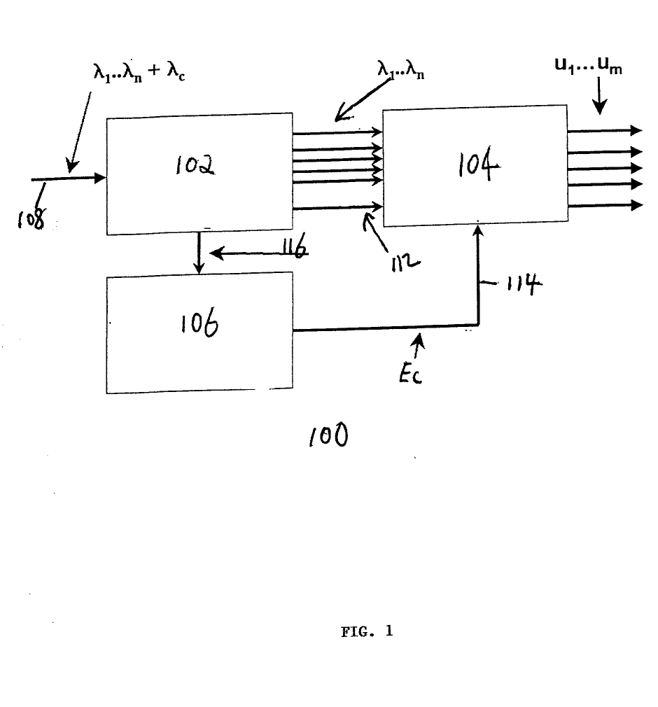

FIG. 1 is an illustration of the overall architecture of an all-optical router system 100. The all-optical router system includes an optical router 104, a wavelength division demultiplexer 102 and an optical/electronic conversion box 106. The λ₁, λ₂, . . . λₙ are the number (n) of wavelengths that are multiplexed on a single fiber 108 along with a control channel carrying a wavelength λ_{c}. The u₁, u₂, . . . uₘ, are the desired m users who need to be connected to any one (or several or all) of the input optical channels carrying each of the wavelengths λ₁, λ₂, . . . λₙ. From now on, for the purpose of simplicity, unless indicated otherwise, where a specified wavelength of λ₁, λ₂, . . . λₙ and λ_{c} is mentioned, the specified wavelength may also represent the optical signal, the optical channel, the light beam, the light radiation or the optical fiber which carries the signal having the specified wavelength. For the same purpose, the words “router” or “switch” have the equivalent meaning in the present invention. When an embodiment is referred to as a router or an optical router, it should be understood that the embodiment is also used as an optical switch in a communications network (and vice versa).

The wavelength division demultiplexer 102 separates out the n signal wavelengths, λ₁, λ₂, . . . λₙ, and the control channel wavelength λ_{c}. The details of the demultiplexer 102 are described below. The optical router system 100 is essentially bi-directional, so the wavelength division demultiplexer 102 can also act as a multiplexer to process the output channels which reversely trace the switching path in the optical router 104 to the originator of the original input optical channels. For the purpose of the detailed description of the embodiments, unless otherwise noted, an input demultiplexer can also function as an output multiplexer although it may not be necessary for it to do so.

After being demultiplexed by the wavelength division demultiplexer 102, the n signal wavelengths λ₁, λ₂, . . . λₙ are sent into the optical router 104 in which the routing is controlled by the signals converted from the control channel λ_{c}.

The λ_{c} separated by the wavelength division demultiplexer 102 is split off into two parts 112 and 116 using conventional technique, for example, using a 3-db split-off to divide the λ_{c}. One part of the split-off λ_{c}, indicated by 112 in FIG. 1, is transmitted along with the signal channels λ₁, λ₂, . . . λₙ into the optical router 104 to implement further control of the signal channels λ₁, λ₂, . . . λₙ if needed. The other part of the split-off λ_{c}, indicated by 116, may be fed into the optical/electronic conversion box 106 which extracts an electronic control signal E_{c} 114 from the λ_{c} 116 and forwards the electronic control signal E_{c} 114 into the optical router 104 to control the optical routing process.

During the operation of the all-optical optical routing system 100, the electronic control signal E_{c} 114 may be generated and received by the optical router 104 prior to the arrival of input optical signals λ₁, λ₂, . . . λₙ being switched by the optical router 104. There are a variety of techniques to ensure that the split-off λ_{c} 116 is converted by the optical/electronic conversion box 106 and is sent to the optical router before the input optical channels are switched. For example, the control channel λ_{c} 116 may be sent to the optical/electronic conversion box 106 in advance. Alternately, the control signal, λ_{c} are preconfigured to arrive ahead of the timing of signals λ₁, λ₂, . . . λₙ to be switched. In addition, the control signal E_{c} 114, may be locally generated for switching the λ₁, λ₂, . . . , λₙ, in a predetermined or locally determined manner. Regardless of the actual technique employed to process and to transmit the electronic control signal E_{c} 114 into the optical router 104, the switching process occurred in the optical router 104 as described below is not affected.

In addition, the optical router 104 does not process the optical header contained in the input optical signal channels λ₁, λ₂, . . . λₙ. This does not affect the routing process performed by the optical router 104 and the electronic control signal E_{c} 114.

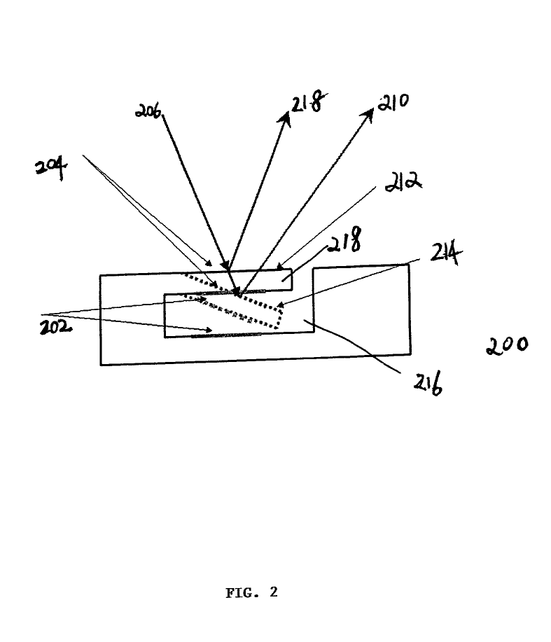

FIG. 2 is a schematic illustration of a micro-mechanical device 200. In accordance with one embodiment of the present invention, the optical router 104 comprises a plurality of the micro-mechanical devices 200. Actual micro-mechanical device configurations may have details which are different from the one shown in the figures. The micro-mechanical device 200 is a conventionally manufactured product such as the mirrors used in Micro Electro Mechanical Systems (MEMS), e.g., Texas Instruments display type of spatial modulator. (Texas Instrument makes a large variety of such devices in their SVGA DMD, SXGA DMA, and etc. categories). The micro-mechanical device 200 can be a multiple mirror assembly made out of silicon with undercuts. As shown in FIG. 2, the silicon device 200 comprises a deflectable mirror 204. The position of the deflectable mirror 204 is controlled by applying an electrical field between the two opposing electrodes 202 of the capacitor 216 formed by the silicon overhang 218. When the deflectable mirror 204 is bent down from the normal position 212 to the deflecting position 214, the input light beam 206 is reflected in the direction of the output deflected light beam 210, which is different from the direction of the normal outgoing light beam 220.

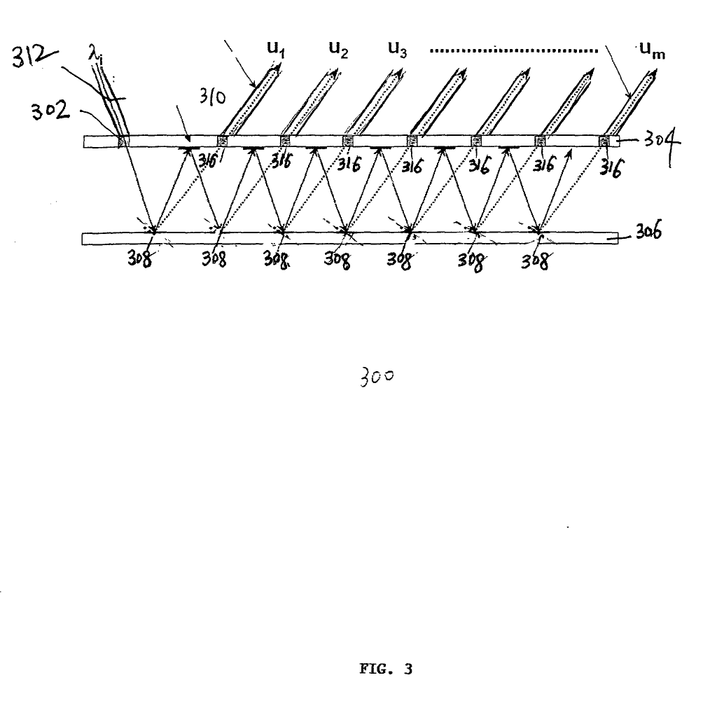

FIG. 3 shows the micro-mechanical mirror assembly 300, which is used to switch a specified wavelength λᵢ (i=1, 2, . . . , n). The micro-mechanical mirror assembly 300 comprises an array of fixed mirrors 304, and an array of deflectable micro-mechanical mirrors 306. The array 306 comprises a plurality of the micro-mechanical device 200. The array of fixed mirrors 304 is separated by evenly positioned openings 316 through which the light beam can enter and exit the switching assembly 300. The input optical fiber 312 is connected to the opening 302; each of the output optical fibers which carry the output optical channels to users u₁, u₂, . . . , uₘ are also connected to the one of the openings 316 as shown in FIG. 3. The array of deflectable micro-mechanical mirrors 306 is placed opposing the array of fixed mirrors 304 as shown. All the mirrors used on the array 304 and the array 306 are conventionally manufactured mirrors with high reflectivity.

The input optical fiber 312 bringing in the wavelength λᵢ is terminated in a SELFOC fiber and/or GRIN lens, which are not shown in FIG. 3. One of ordinary skill in the art would recognize that the use of SELFOC fiber and/or GRIN lens enables the emerging light in the optical fiber 312 to be converted from a fiber guided mode to a free space propagation mode and to be collimated. The SELFOC fiber and GRIN lens may be the products of NSG America, Inc., 27 World's Fair Drive, Somerset, N.J. 08873. The input light beams containing wavelength λ₁ enter the optical router assembly 300 and are reflected back and forth between the array of deflectable mirrors 306 of the micro-mechanical mirror assembly 300 and the opposing array of fixed mirrors 304. In absence of any control signal E_{c} 114, the wavelength λᵢ from the input optical fiber 312 is not directed to any of output fibers connecting to the users.

When commanded by the control signal channel E_{c} 114, each of the micro-mechanical mirrors 308 on the array 306 is capable of moving to the deflecting position shown by dashed line in the FIG. 3. The input light beam is then correspondingly deflected in a direction to pass through one of the openings 316 in the array 304 to enter the output optical fiber connected to the desired user.

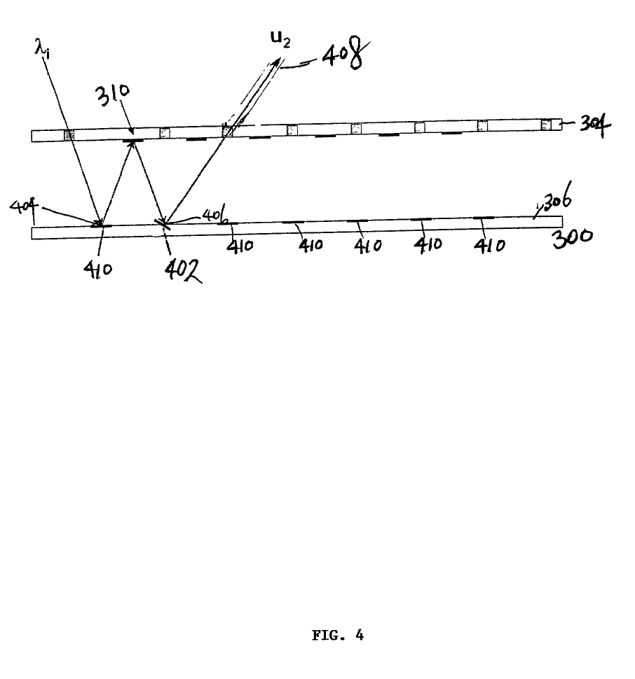

FIG. 4 shows that the mirror assembly 300 switches the input channel corresponding to wavelength λᵢ to the output optical fiber 408, which is connected to the intended user u₂. In order to switch λᵢ to the user u₂, the mirror 402 on the array 306 is switched to the deflecting position 406 while all other mirrors 410 on the array 306 will remain in the normal position 404. As a result, the input signal λᵢ is switched to the direction connected to u₂ where an appropriate SELFOC fiber and/or GRIN lens in the output fiber 408 can couple the collimated light beam into the output fiber 408. Likewise, with the imposition of appropriate control command signals E_{c} 114, the input channel λᵢ will be deflected into any one of the output fibers uⱼ (where j=1 through m) when a predetermined mirror 410 on the array of deflectable mirrors 306 is commanded to switch to a deflecting position.

In accordance with one aspect of the present invention, since the deflectable mirrors on the array 306 only need to be switched between a normal position and a deflecting position, as shown in FIG. 3 and FIG. 4, the control signal E_{c} 114 that determines the mirror position can be simplified into a binary signal that determines the mirror positions. For example, the E_{c} 114 may use “0” to represent the normal position of the deflectable mirror and “1” to represent the deflecting position of the deflectable mirror. Unlike the present invention, the conventional technique has to switch microscopic mirrors at varied positions by complex analog control signals to reflect the input light beam into designated output optical fibers. The present invention overcomes the limitations and deficiencies of such analog control and avoids positional errors which may be caused by the analog switching of the micro-mechanical mirrors.

All of the mirrors used on the array 304 and 306 are high-reflectivity mirrors and, therefore, the throughput loss through this optical router is negligible. One of ordinary skill in the art would recognize that if these mirrors are 99.9 percent reflective, the reflection loss incurred at each mirror is only 0.1 percent. For example, in the case of 32 output user channels connected to the optical router 104, there are 63 reflections for coupling the input wavelength to the 32nd user. The maximum throughput loss will not exceed 6.3 percent.

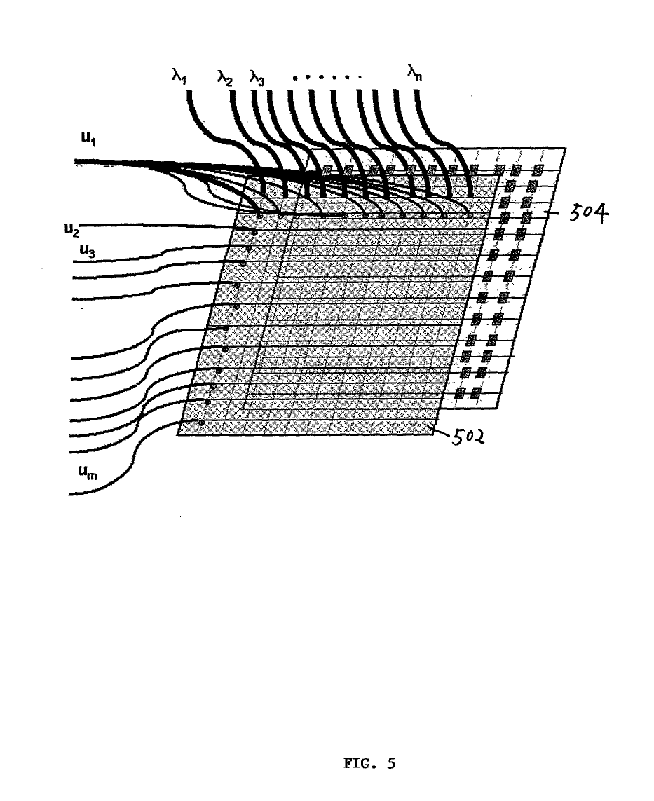

FIG. 5 illustrates the two dimensional configuration of n wavelength signals switched to m users in accordance with one embodiment of the present invention. The embodiment includes two mirror assemblies, the first being the silicon chip 504 wherein micro-mechanical mirrors are arrayed in a number of rows and columns and the second being an assembly containing the fixed mirrors. A plurality of input optical channels, respectively corresponding to wavelength λ₁, λ₂, . . . λₙ, is connected to the corresponding columns of the top chip 502. A plurality of output optical fibers respectively connecting to m users, u₁, u₂, . . . uₘ, are connected to the corresponding rows of the top chip 502. In a way similar to what has been described in FIG. 3 and FIG. 4, a specified input wavelength channels λ₁ is coupled through corresponding columns (or rows) into any one of the output m channels by switching predetermined deflectable mirrors on the silicon chip 504 under the control of signal E_{c} 114. FIG. 5 further shows that the pigtails from each of the jth (j=1, 2, . . . m) output fiber from each of the input columns, i, will be fused together to form a single output fiber j using conventional optical fusing techniques. In this way any number of the input wavelength channel λᵢ can be coupled into any of the output user fibers uⱼ.

It should be noted that that nothing precludes coupling more than one of the input wavelengths, or even all of them, into the same output fiber by switching the same numbered mirror on all of the input channels. Furthermore, nothing precludes placing the control channel λ_{c} 112 back on one or several or all of the output fibers for future control at a later point in the transmission.

In addition, the embodiment described in FIG. 5 for connecting all the n different wavelength outputs to one user through the utilization of a fused fiber requires that the output fiber support the multiplicity of optical fiber modes in order to be bidirectional and wavelength insensitive.

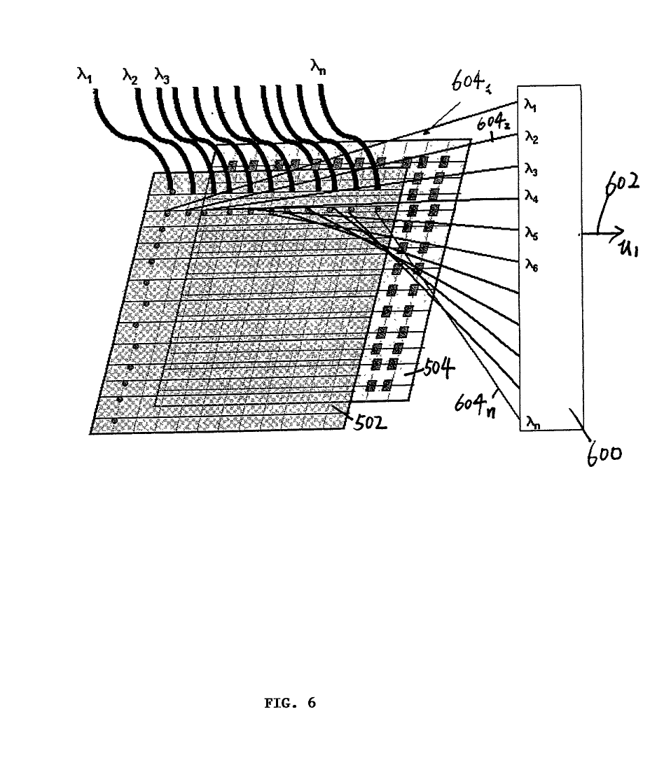

FIG. 6 further illustrates another two dimensional configuration of an optical router switching n wavelength channels to m users with an optical combiner wherein the output fiber 602 connected to the user u₁ supports single mode transmission.

Similar to the embodiment described in FIG. 5, the embodiment in FIG. 6 also includes one micro-mechanical mirror silicon chips 504 and another fixed mirror assembly 502, n input fibers carrying wavelengths λ₁, λ₂, . . . λₙ and n output fibers directing the input wavelengths to each of the m users.

As shown in FIG. 6, instead of fusing the output fibers together to the user u₁, the embodiment connects the output fibers 604₁, 604₂, . . . , 604ₙ, to an optical combiner 600. In order to provide for bi-directionality of optical signals passing through the optical router, the optical combiner 600 which has n different possible inputs λ₁, λ₂, . . λₙ can be at least one of the two kinds described below.

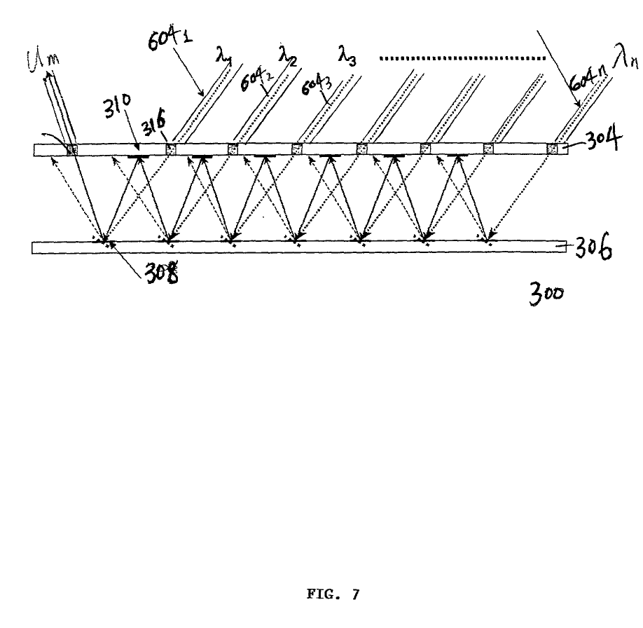

In the first case where the returning wavelength from user u₁, for example, is known or can be prescribed by a central control unit, the switching arrangement can be reversed, as shown in FIG. 3 and FIG. 4, to direct a specific wavelength to the user u₁. This requires the same switching information that was used to direct a specific wavelength to user u₁ in FIG. 3 and FIG. 4. This is schematically shown in FIG. 7. Using a two dimensional configuration of the micro-mechanical mirror assembly, any of the input wavelengths λᵢ coming from the output fiber 604ᵢ (i=1, 2, . . . n) will be directed to the user m as shown.

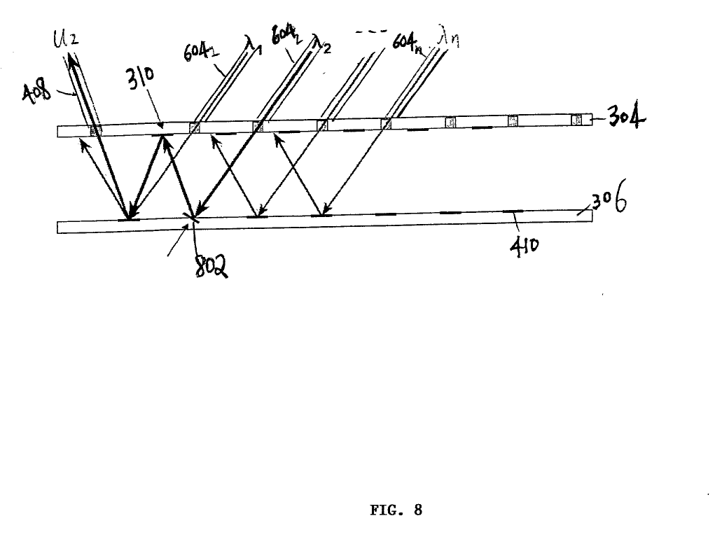

Specifically, referring to FIG. 4, the input optical signal corresponding to the wavelength λᵢ is switched to user 2. FIG. 8 illustrates how an input λᵢ is switched to the user u₂ on a single mode fiber by coordinating the switching of MEMS mirrors appropriately. As shown in FIG. 8, the λ₂, carried by the fiber 604₂, is deflected by the switched mirror 802 to the mirror 310 and then bounce on the mirror 804 up the output fiber 408, which connects to the user u₂. FIG. 8 also shows that the inputs from other fibers carrying other wavelengths to/from the user u₂ (which would not be present) are not reflected to the user u₂. The return signal from user u₂, at the same wavelength as the received signal at wavelength λᵢ, retraces the exact path shown in FIG. 8 and FIG. 4, thus providing bi-directionality to the optical router.

In the second case where the returning wavelength from the user uₘ is not specified to be the same as the received wavelength λᵢ, the present invention uses a wavelength division multiplexer/demultiplexer to route any potential input wavelength λᵢ to the user uₘ. This accommodates the return wavelength being different from that going to the user for the purpose of maintaining the bi-directionality of switching the optical channels. The details of this are described below.

For the embodiments described herein, the present invention can switch the input channels λ₁, λ₂, . . . λₙ at a speed at which the deflectable mirrors on the array 306 shown in FIG. 3 can be switched. The mirror switching speed at present is in the range of 10⁴ to 10⁶ per second.

For instance, with a conservative number of 16 input wavelengths, λᵢ entering the optical router 104, 32 intended users to whom the input wavelength streams are switched, a channel bit rate of 10 gigabits per second, and a channel switching speed of 10⁵ sec⁻¹, the optical router switching speed is:

Router Speed=16×10×10⁹×10⁵=1.6×10¹⁶ sec⁻¹ =16 petabytes per second.

It is noted that that the switching speed of the MEMS mirror is far slower than the rate at which the E_{c} signal can be changed. The overall speed of the router increases linearly with the switching speed of the MEMS mirrors. Thus as the MEMS technology improves and/or other switching devices become available, the router speed as defined above will scale up. Furthermore even though MEMS mirrors have been hitherto used in these embodiments, it is not a limiting feature of the invention. As shown below, any device that can deflect (or refract) a beam of light under the control of E_{c} signal 114 can be used in accordance with the present invention.

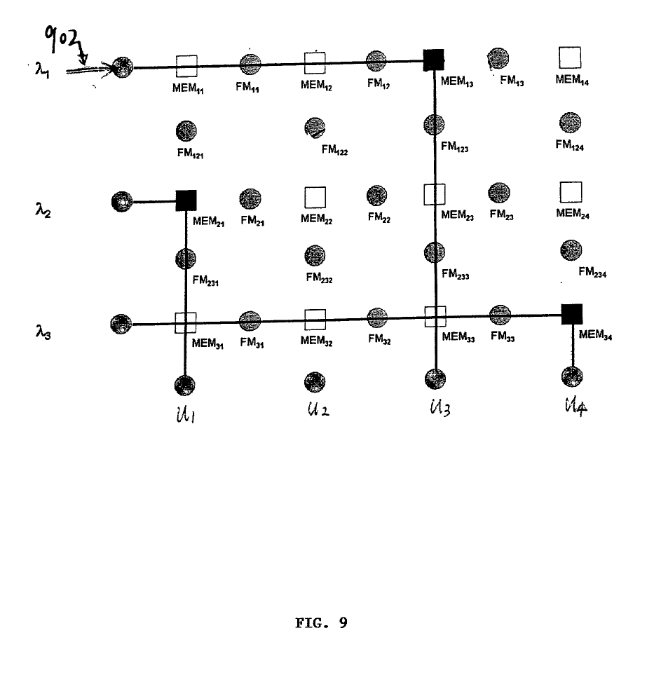

FIG. 9 is a schematic illustration of an alternative embodiment to what has been described in FIG. 6 for a single MEMS switch for optical routing. In FIG. 9, the mirror FMᵢⱼ (i, j=1, 2,. . . n), which face down to a MEMS mirror plane, represents the fixed mirrors in a top stationary reflector plane. MEMᵢⱼ (i, j=1, 2 . . . n), which face up towards the stationary reflector plane, represents the switchable mirrors located in a switchable MEMS mirror plane. The input optical fiber 902 is entering through the top stationary reflector plane. g

FIG. 9 further shows that the MEMS mirror MEM₁₃ is switched in order to connect input wavelength λ₁ to user u₃. The light path to switch the λ₁ to user u₃ is as follows:

Input λ₁ arrives on the fiber 902 and bounces up from the unswitched MEM₁₁ mirror; the input λ₁ strikes the FM₁₁ fixed mirror and bounces down from the FM₁₁ fixed mirror; the input λ₁ bounces up from the unswitched MEM1₂ mirror; the input λ₁ bounces down from FM₁₂ fixed mirror; the input λ₁ bounces up from the switched MEM₁₃ mirror; the input λ₁ further bounces down from the FM₁₂₃ fixed mirror; the input λ₁ bounces up from the unswitched MEM₂₃ mirror; the input λ₁ bounces down from the FM₂₃₃ fixed mirror; the input λ₁ bounces up from the unswitched MEM₃₃ mirror; and finally the input λ₁ enters the output fiber which directs the switched λ₁ to user u₃.

Similarly, the present invention can trace the paths for connecting input λ₂ to user u₁, and for connecting input λ₃ to user u₄. Thus, the n(λ) inputs can be arbitrarily connected to any of the m users by switching appropriate MEMS mirrors.

In addition, this two dimensional system ensures bi-directionality without using multiple and separate MEMS mirrors although such an embodiment is operative. For the description in FIG. 9, a return wavelength λ₁ from the user u₃ can retrace the same path to the originator of the switched wavelength λ₁.

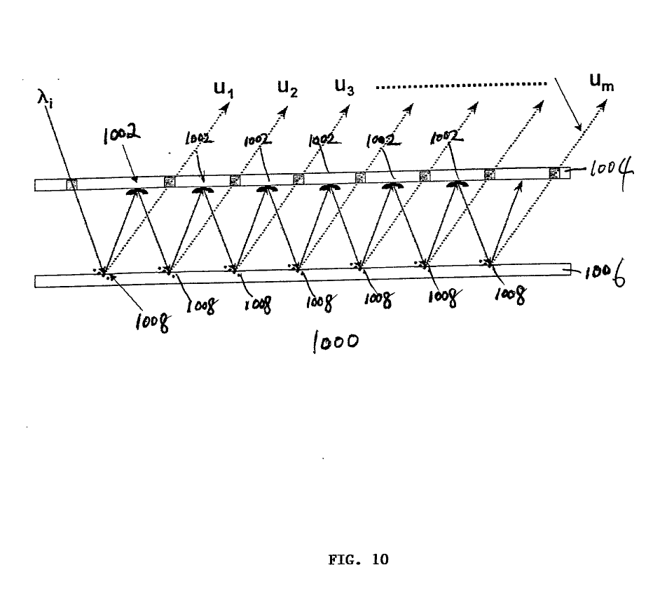

FIG. 10 shows an all-optical router 1000 with curved fixed mirrors 1002 in accordance with one aspect of the present invention. This embodiment of the present invention uses curved fixed mirrors 1002 instead of the flat fixed mirrors, as shown in FIG. 3, to keep the input radiation from the input fibers focused as it bounces back and forth between the switchable mirror plane 1006 and the fixed mirror plane 1004. In FIG. 10, the input light beam now bounces back and forth between the flat MEMS mirrors 1008 and curved fixed mirrors 1002. By choosing the proper focal length for these fixed mirrors 1002, the present invention can relay the input light λᵢ over the entire switching distance without any significant radiation spreading or cross coupling (confocal relaying). Thus, the present invention does not need to account for the Raleigh length of the input beam, which would have otherwise determined how far one input light beam can bounce the light back and forth between the flat mirrors 310 and 410, for example before the beam width becomes large enough to lead significant coupling of light to an undesired user fiber thereby causing cross talk. For light bouncing between the flat mirrors 1008 and curved fixed mirrors 1002, light remains tightly focused..

The curved fixed mirrors 1002 can be used with the single row (or column) geometry shown in FIG. 3, 4, 7, and 8 and the two dimensional geometry shown in FIG. 9. The curved fixed mirrors are also applicable to the embodiments to be described below.

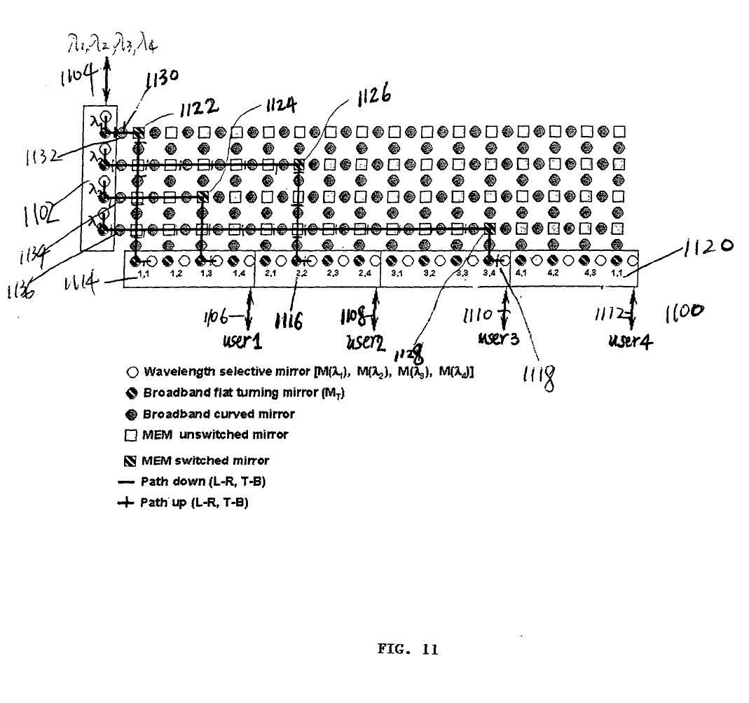

FIG. 11 illustrates another embodiment of the present invention wherein an optical switch/router/cross-connect is capable of switching any combination of wavelengths to any of the users, i.e., optical signals having one wavelength, a subset of all wavelengths, or all relevant wavelengths can be sent to any user depending upon the need.

FIG. 11 provides an example of four input wavelengths λ₁, λ₂, λ₃, λ₄ coming in on a single wavelength division multiplexed (WDM) fiber 1104 and being switched to any of the four users: user 1, user 2, user 3, user 4.

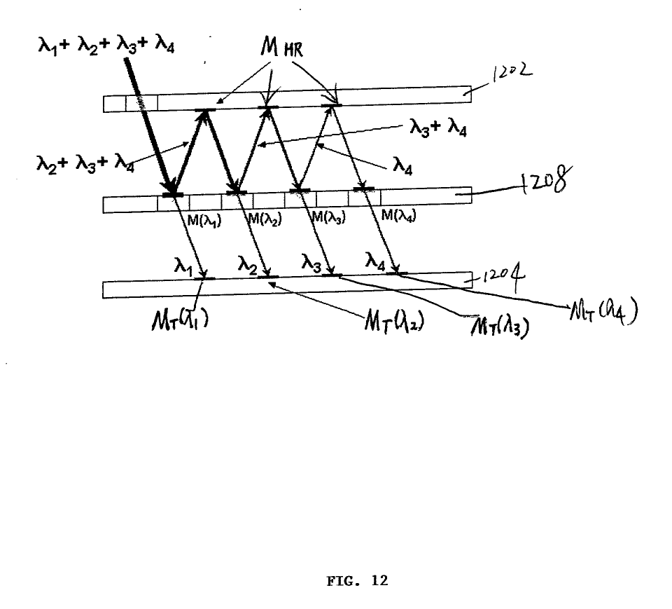

FIG. 11 shows that an Input/Output Multiplexer/Demultiplexer (I/O Mux/Demux) 1102 is incorporated onto the silicon chip assembly 1100 that will be performing the switching of input optical signals received from the WDM fiber 1104 to the output optical fibers 1106, 1108, 1110, 1112, which respectively connects to user 1, user 2, user 3 and user 4. The I/O Mux/Demux 1102 is constructed using thin film filters that transmit only one of the selected wavelengths and reflect all other wavelengths. The I/O Mux/Demux 1102 will be described in greater detail below with reference to FIG. 12.

The WDM fiber 1104 carrying the WDM wavelengths λ₁, λ₂, λ₃ and λ₄ comes in from a top stationary reflector plane of the silicon chip assembly 1100. The WDM 1104 goes through a fiber-to-free space conversion using appropriate lenses, GRIN lenses and/or other mechanisms. The input radiations λ₁, λ₂, λ₃ and λ₄ are injected into the I/O Mux/Demux 1102.

FIG. 11 also illustrates that the I/O Mux/Demux 1102 separates the four wavelengths λ₁, λ₂, λ₃, λ₄ and sends them, using the flat turning mirrors M_{T} to the four horizontal switching MEMS mirror paths. For λ₁, the present invention switches the MEMS mirror 1122, to selectively send this wavelength to the λ₁ port of the USER 1 Multiplexer/Demultiplexer (Mux/Demux) 1114. For λ₂, the present invention switches the MEMS mirror 1126 to send that wavelength to the λ₂ port of the USER 2 Mux/Demux 1116. For λ₃, the present invention switches the MEMS mirror 1124 to send this wavelength to the λ₃ port of the USER 1 Mux/Demux 1114. For λ₄, the present invention switches the MEMS mirror 1128 to send this wavelength to the λ₄ port of the USER 3 Mux/Demux 1118.

Further, USER 1 Mux/Demux 1114 combines the λ₁ and λ₃ wavelengths to send them to the fiber 1106 going to user 1. USER 2 Mux/Demux 1116 takes λ₂ wavelength to send it to the fiber 1108 going to user 2. USER 3 Mux/Demux 1118 takes λ₄ wavelength to send it to the fiber 1110 going to user 3. In the example shown in FIG. 11, no wavelength is going to user 4.

The paths of the embodiment shown in FIG. 11 are completely reversible. This system thus provides a full bi-directionality in switching the input wavelengths.

Further, the bi-directionality provided by the present invention and the configuration shown in FIG. 11 enable the optical router shown in FIG. 11 to automatically detect the failure of any output optical fibers and restore the signal switching by reallocating channels. For example, if transmission errors or channel failure occur in the original path shown in FIG. 11, the control signal E_{c} 104 may be re-configured to switch the position of one or more than one micro-mechanical mirrors to deflect the input light beam into the desired user.

The embodiment illustrated in FIG. 11 is not limited to four input wavelengths and four users. The present invention can connect any number of wavelengths and any number of users by appropriately configuring the MEMS router/switching fabric and user Multiplexer/Demultiplexer combinations as shown in FIG. 11. In addition, the feature of the curved relaying fixed mirrors as shown in FIG. 10 minimizes cross coupling of radiation among the different input optical signals wavelength and maintains a small size of the micro-mechanical mirror assembly.

All of these features described above simplify the manufacturing and maintenance of the optical router. Use of this configuration lends itself to easy to manufacture because there are no adjustments that need to be made and the assembly is keyed to mechanical fiducial marks.

FIG. 12 illustrates the operation of the four wavelengths I/O Mux/Demux 1102. The I/O Mux/Demux 1102 includes three parallel plates 1202, 1208 and 1204. The plate 1202, 1208 and 1204 can be made of glass, quartz, or other material. There is a plurality of high reflectivity broadband mirrors M_{HR} on the plate 1202. On the plate 1208, the mirrors M(λᵢ) (i=1, 2, 3, 4) only allow signals having a wavelength of λᵢ to pass through. For example, the mirror M(λᵢ) may have a narrow notch transmission only at the wavelength λ₁. On the plate 1204, there are four high reflectivity broadband turning mirrors M_{T}(λ₁), M_{T}(λ₂), M_{T}(λ₃) and M_{T}(λ₄).

In FIG. 12, the input radiation, λ₁, λ₂, λ₃ and λ₄, first encounter the mirror M(λ₁) which allows signals λ₁ to pass through. As a result, the wavelength λ₁ transmits through the mirror M(λ₁) and impinges on the broadband high reflectivity turning mirror M_{T}(λ₁) on the plane 1204. Other wavelengths, λ₂, λ₃, and λ₄, are reflected back up toward a high reflectivity broadband mirror M_{HR} . On the plate 1208, the λ₂, λ₃, and λ₄ radiation then impinges on the mirror M(λ₂) which has high reflectivity at λ₁, λ₃, and λ₄ but has a notch transmission at λ₂. Thus, the λ₂ wavelength signal passes through the mirror M(λ₂) and impinges on the λ₂ broadband turning mirror M_{T}(λ₂).

The reflected radiation which consists of λ₃ and λ₄ is moving up to the second high reflectivity mirror M_{HR} on the top and is reflected back downward on the M(λ₃) which is high reflectivity at λ₁, λ₂, and λ₄ but has a notch transmission at λ₃. The transmitted λ₃ then impinges on broadband turning mirror M_{T}(λ₃).

Now the reflected radiation consisting only of λ₄ is moving up and is reflected down towards M(λ₄), which is high reflectivity at λ₁, λ₂, and λ₃ but has a notch transmission at λ₄. The transmitted λ₄ now impinges on the broadband flat turning mirror M_{T}(λ₄). The high reflectivity broadband mirrors M_{HR} may be curved in a manner similar to the high reflectivity curved mirrors 1002 described above.

In addition, the optical paths described above are retraceable, i.e., in the reverse direction, the demultiplexer can act as a multiplexer.

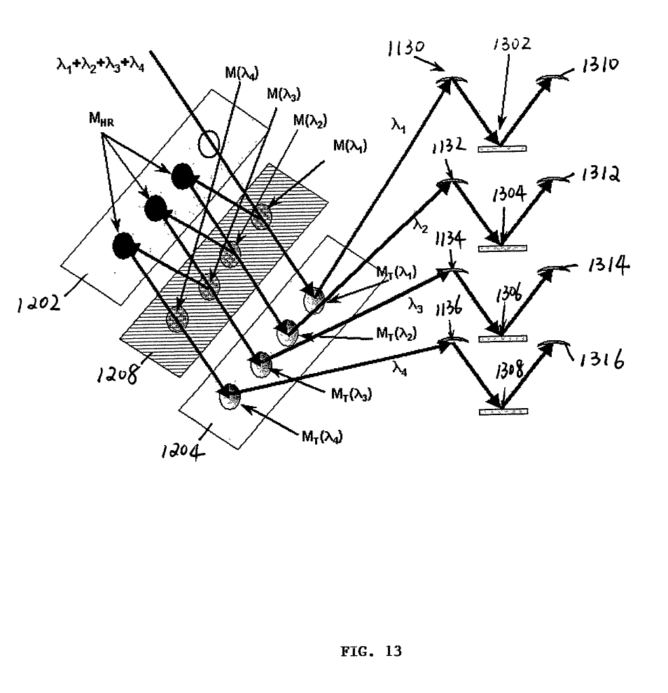

FIG. 13 is an illustration of the operation of the I/O Mux/Demux 1102 in separating the λ₁, λ₂, λ₃, and λ₄ signals and coupling each of the wavelengths into the respective MEMS rows. The broadband flat turning mirrors M_{T}(λ₁), M_{T}(λ₂), M_{T}(λ₃), and M_{T}(λ₄) direct the radiation in a corresponding row (or column) of the router/switch fabric 1100 and reflect back up to the first of the broadband curved mirrors.

M_{T}(λ₁), the turning mirror for λ₁ reflects the wavelength λ₁ into the λ₁ row of the MEMS router/switch fabric 1100. M_{T}(λ₂ ), the turning mirror for λ₂, reflects the wavelength λ₂ into the λ₂ row of the MEMS router/switch fabric 1100. M_{T}(λ₃), the turning mirror for λ₃, reflects the wavelength λ₃ into the λ₃ row of the MEMS router/switch fabric 1100. M_{T}(λ₄), the turning mirror for λ₄, reflects the wavelength λ₄ into the λ₄ row of the MEMS router/switching fabric 1100.

The curved broadband mirrors 1130, 1132, 1134, 1136 relay the particular wavelength radiation in a confocal manner keeping the radiation focused to minimize beam spreading, associated loss, and associated cross coupling, which may result from the spill-over into other MEMS rows and/or columns as described above.

The MEMS switching mirrors 1302, 1304, 1306, 1308, when unswitched, relay the light directly to the next broadband curved mirrors 1310, 1312, 1314, and 1316.

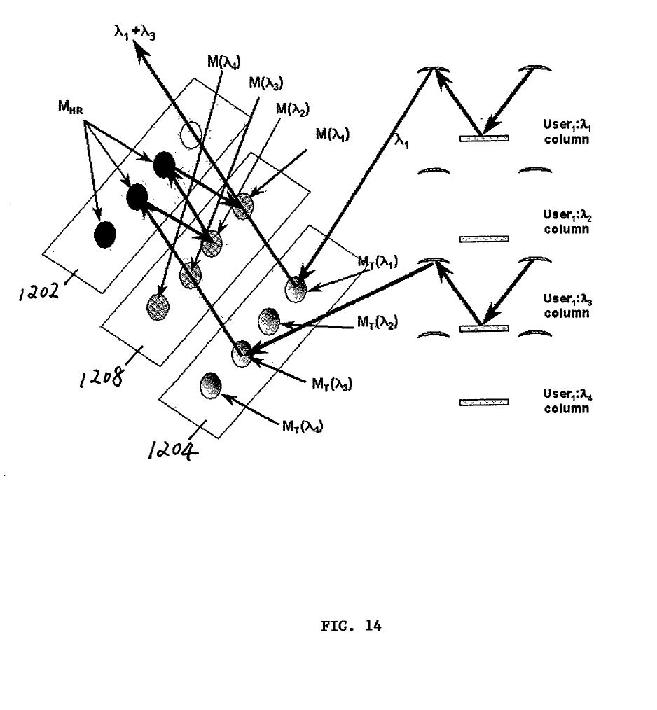

FIG. 14 now shows the operation of the USER 1 Mux/Demux 1114 in transmitting the switched λ₁ and λ₃ signals to user 1 via the output fiber 1106. As depicted in FIG. 14, the USER 1 Mux/Demux 1114 may adopt the same structure as the I/O Mux/Demux 1102, which is described in FIG. 12, given the full bi-directionality capability of the present invention.

As described above, the MEMS mirror 1122 reflects the λ₁ radiation into the λ₁ port of the USER 1 Mux/Demux 1114. The MEMS mirror 1124 reflects the λ₃ radiation into the λ₃ port of the USER 1 Mux/Demux 1114. In FIG. 14, the λ₁ port of the USER 1 Mux/Demux 1114 is indicated by USER 1: λ₁ column. The notation shows the user receiving the radiation and wavelength of the radiation. The same notation method are also applicable to the λ₃ port of the USER 1 Mux/Demux 1114 as well as other wavelength ports of other user multiplexer/demultiplexers described herein.

As shown in FIG. 14, the wavelength λ₁ comes down through USER₁: λ₁ column and λ₃ comes through USER₁: λ₃ column. Similar to what are described in FIG. 12 and FIG. 13, the λ₁ is reflected off the broadband turning mirror M_{T}(λ₁) and is transmitted through M(λ₁). As described in FIG. 12 and 13, the characteristics of M(λ₁) (i=1,2,3,4) allows only specified wavelength λᵢ to pass through the M(λᵢ) while the rest of wavelengths are reflected off the mirrors M_{HR} . Therefore, λ₁ can be directed to the plate 1202 and enters the output fiber 1106 to the user 1.

With respect to λ₃, λ₃ which comes down through USER₁: λ₃ column into the USER 1 Mux/Demux 1114, is reflected by the broadband turning mirror M_{T}(λ₃) and is transmitted through M(λ₃). The λ₃ reflects off the mirror M_{HR} , and subsequently from M(λ₂) which has high reflectivity at λ₁, λ₃, and λ₄, and again by mirror M_{HR} and finally by mirror M(λ₁) which as mentioned above has high reflectivity at λ₂, λ₃, and λ₄. On this reflection, λ₃ combines with λ₁ coming through the mirror M(λ₁) and the λ₁+λ₃ output is carried to USER 1 as intended over the fiber 1106 (converting the free space propagation to fiber propagation through the use of appropriate focusing elements). Again, it should be understood that USER 1 Mux/Demux 1114 is a bi-directional device, and therefore, the return wavelengths λ₁+λ₃ coming from user 1 will reversely trace the paths of λ₁, and λ₃ described above.

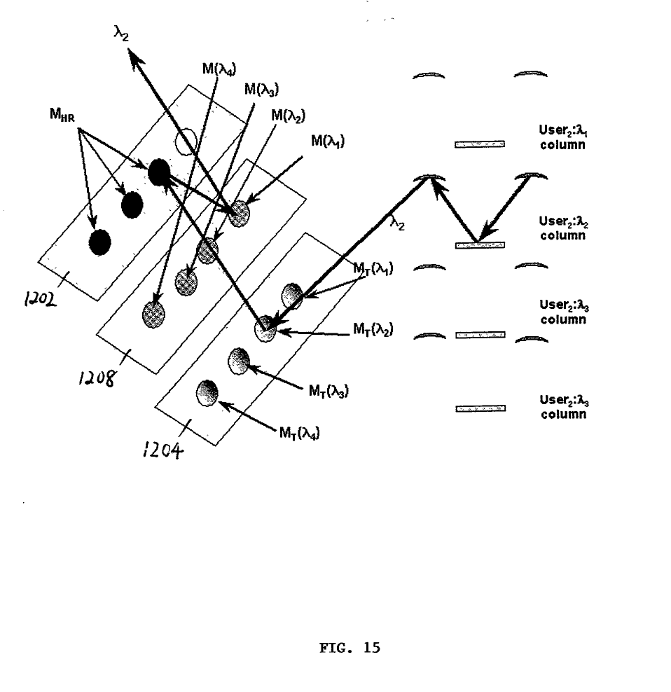

FIG. 15 illustrates the operation of the USER 2 Mux/Demux 1116 for transmitting switched λ₂ signal to user 2 in the optical router/switch fabric 1100 shown in FIG. 11. As described above, 12 is separated out from the input stream by the I/O Mux/Demux 1102 and is deflected by the mirror 1126 into the λ₂ port of the user 2 Mux/Demux 1116, which is the USER 2:λ₂ column in FIG. 15.

Referring to FIG. 15, which depicts in details the operation of the USER 2 Mux/Demux 1116 in switching λ₂ to user 2, the M_{T}(λ₂) receives the switched λ₂ radiation from the USER 2:λ₂ column. The λ₂ signal is transmitted through the mirror M(λ₂) which has high transmissivity at λ₂ but is high reflectivity at the other three wavelengths, λ₁, λ₃, and λ₄. The λ₂ signal is now reflected from broadband flat mirror M_{HR} to mirror M(λ₁) which has high transmissivity at λ₁ but is high reflectivity at the other three wavelengths, λ₂, λ₃, and λ₄. As a result, M(λ₁) now reflects the λ₂ signal out from the USER 2 Mux/Demux into the fiber 1108 going to user 2 (after appropriate mode conversion from free space propagation to fiber propagation).

Again, USER 2 Mux/Demux 1116 is bi-directional, and therefore the return wavelength λ₂ from USER 2 can reversely trace the path of the forward radiation as described above and will go back to the input/output fiber 1102.

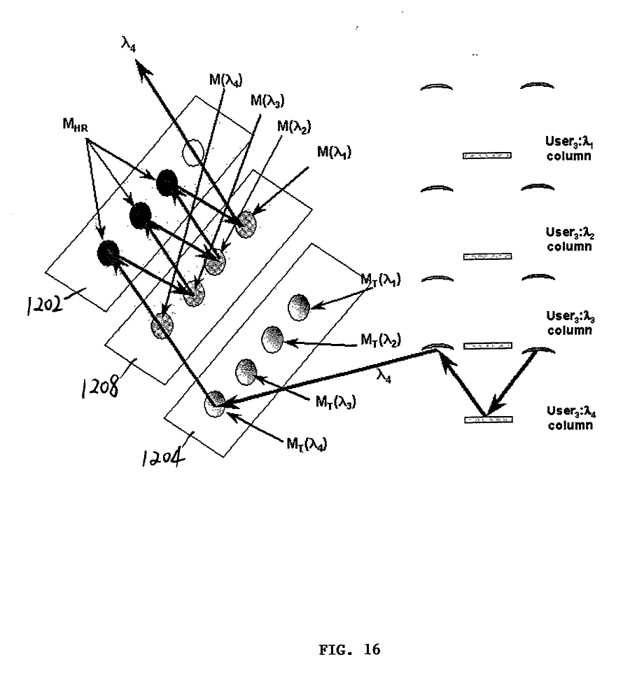

Similarly, FIG. 16 depicts the operation of the USER 3 Mux/Demux 1118 to direct the signal λ₄ to user 3. With reference to FIG. 11, the λ₄ signal is separated out by the I/O Mux/Demux 1102 and is propagating along the λ₄ row bouncing back and forth between the unswitched MEMS mirrors and the confocal relaying broadband curved mirrors until λ₄ signal encounters the switched MEMS mirror 1128. The switched mirror 1128 deflects λ₄ to the λ₄ of the USER 3 Mux/Demux 1118, which is the USER 3: λ₄ column. Referring now to FIG. 16, the M_{T}(λ₄) turning mirror receives the switched λ₄ signal from the USER 3:λ₄ column and transmits the λ₄ signal through the element M(λ₄) which has high transmissivity at λ₄ and high reflectivity at λ₁, λ₂, and λ₃. The λ₄ wavelength is now reflected back from mirror M_{HR} on to M_{T}(λ₃) which has high reflectivity at λ₁, λ₂, and λ₄ and high transmissivity at only at λ₃. Then λ₄ is reflected from the next mirror M_{HR} to M_{T}(λ₂) which has high reflectivity at λ₁, λ₃, and λ₄, and high transmissivity at λ₂. Finally, the λ₄ signal is reflected off the next mirror M_{HR} on to the mirror M_{T}(λ₁) which has high reflectivity at λ₂, λ₃, and λ₄, and high transmissivity at λ₁. The λ₄ signal then exits the USER 3 Mux/Demux 1118 and is coupled into the optical fiber 1110 going to user 3 through the use of appropriate mode coupling elements.

As described above, the router/switching fabric 1100 is completely bidirectional and therefore the return λ₄ signal from user 3 can reversely trace the path of forward λ₄ signal described above, and will go through the I/O Mux/Demux 1102 to the input/output fiber 1104 as shown in FIG. 11.

The operation of the USER 4 Mux/Demux is not described here since in the example given in FIG. 11, none of the wavelengths are switched to user 4. According to the foregoing description of other Multiplexer/Demultiplexers, it is apparent to one of ordinary skill to recognize the operation of the USER 4 Mux/Demux 1120 is capable of switching any combinations of the input wavelengths to the user 4.

It can also be seen that even though the example given in FIG. 11 deals with four wavelengths λ₁, λ₂, λ₃, and λ₄ coming into the wavelength router through the input/output fiber, the present invention can be applied to any number of input multiplexed wavelengths. Thus, the invention is scalable to arbitrary number of wavelengths.

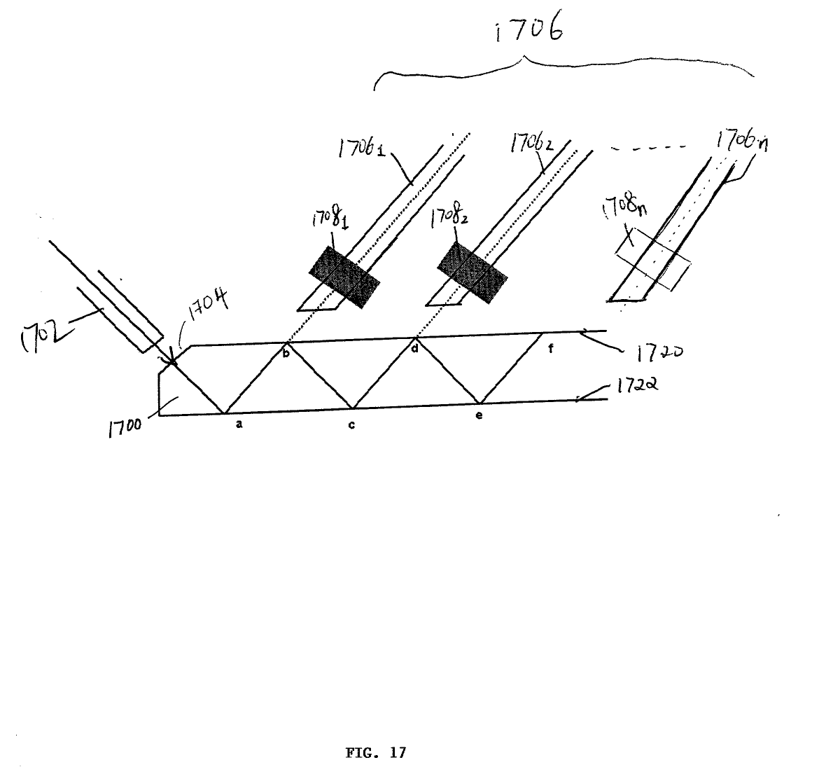

FIG. 17 illustrates an alternative embodiment of the optical router 104. A solid-state quartz device 1700, is made of high quality quartz or alternatively made of any other low loss optical material at the range of the wavelengths that can be used for optical signal transmission. The quartz device 1700 has an end with an angle cut 1704 for ease of admitting the input radiation that needs to be switched to a number of users (and extracting the return signal that comes from the users). The input fiber 1702 includes appropriate lenses to couple the radiation from the guided fiber mode to a free space-propagating mode.

Fibers 1706₁, 1706₂, . . . , 1706ₙ, collectively referred to as 1706, are n number of output optical fibers respectively connecting to users 1, 2, . . . , n. As shown in FIG. 17, the end of each of the fibers 1703 is parallel to the flat surface of the quartz device 1700. Each of the fibers 1703 has built-in lenses or SELFOC fiber and/or GRIN lenses or other mechanism to convert the free space propagating mode into a fiber guided mode (and vice versa).

For each of the output optical fibers 1706, there are associated piezoelectric drivers 1708₁, 1708₂, . . . , 1708ₙ that are capable of positioning the respective output fibers 1706₁, 1706₂, . . . , 1706ₙ by moving them along the direction of the fiber axes.

Radiation from the input fiber 1702 is injected into the device 1700 such that the light is reflected back and forth between the two flat internal surfaces 1720 and 1722 of the quartz device 1700 as shown at point a, b, c, d, e, f, etc. with a total internal reflection with no significant reflection losses. At this point of operation, all of the output optical fibers 1706 are retracted back to be away from the external surface of the quartz device 1700 by a non-coupling distance, which is approximately 10-20 times the wavelength, i.e., for a wavelength approximately at 1.5 μm, the non-coupling distance of the embodiment would be approximately 15-30 μm. At such non-coupling distance, no “connection” or coupling of radiation occurs between any of the output fibers 1706₁, 1706₂, . . . , 1706ₙ and their corresponding points where the light is totally internally reflected at points b, d, e . . . etc.

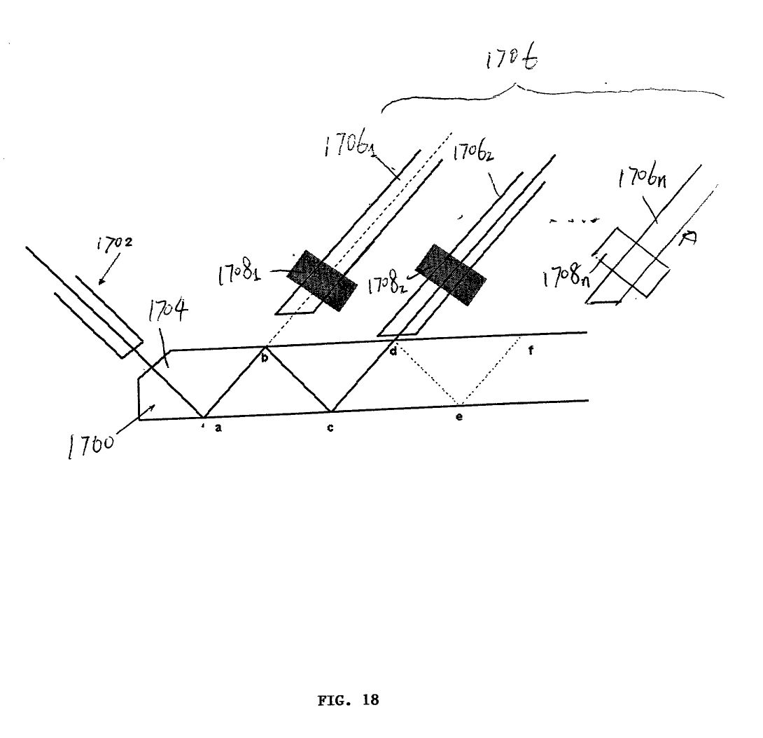

FIG. 18 illustrates the process of switching the input radiation from input fiber 1702 to the user 2. In order to switch the input radiation to the user 2, an operative electric voltage is applied to the 1708₂ piezoelectric driver so that the fiber 1706₂ is now brought into proximity of the point d in FIG. 18. When the tip of the fiber 1706₂ is within a small fraction of the input radiation wavelength, the light propagating along the direction c-d sees a continuous refractive index that results in essentially no reflection of the light rather than the quartz-air interface that gave rise to the total internal reflection described in the previous example. Now all the radiation propagating along the path c-d is coupled from the quartz device 1700 into the fiber 1706₂. A reverse coupling is also simultaneously accomplished. In doing so, the signal coming from the input fiber 1702 is switched to the user fiber 1706₂, and no radiation propagates beyond point d as shown in FIG. 18. The switching speed can be very fast because piezoelectric driver 1708₂ is used to move the fiber 1706₂ in and out at the direction of the axis of the fiber 1706₂.

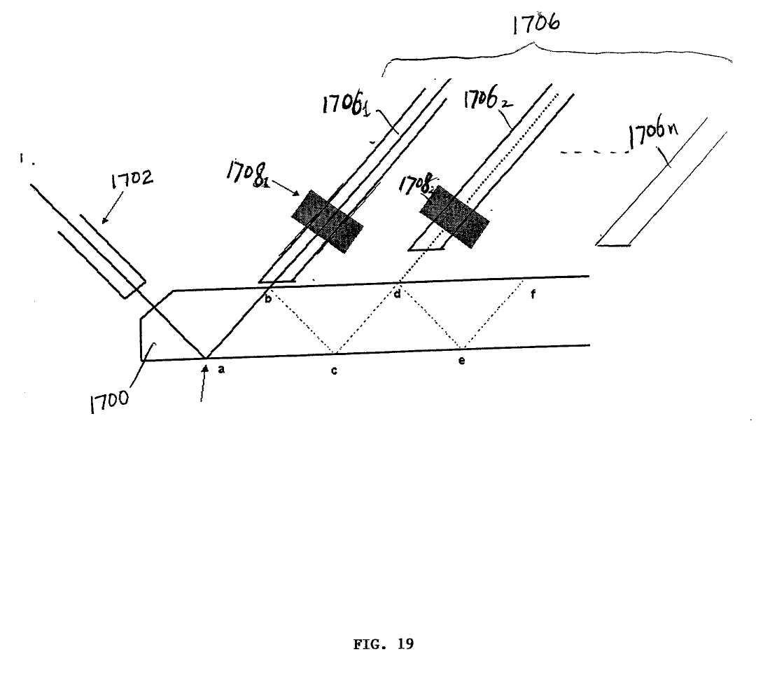

FIG. 19 further shows the switching of signals carried on the input fiber 1702 to user 1. Likewise, the piezoelectric driver 1708₁ would be activated to move the fiber 1706₃ into proximity of the quartz device 1700. Thus, no light travels in the quartz device 1700 beyond point b and is coupled into the fiber 1706₁ and eventually received by user 1.

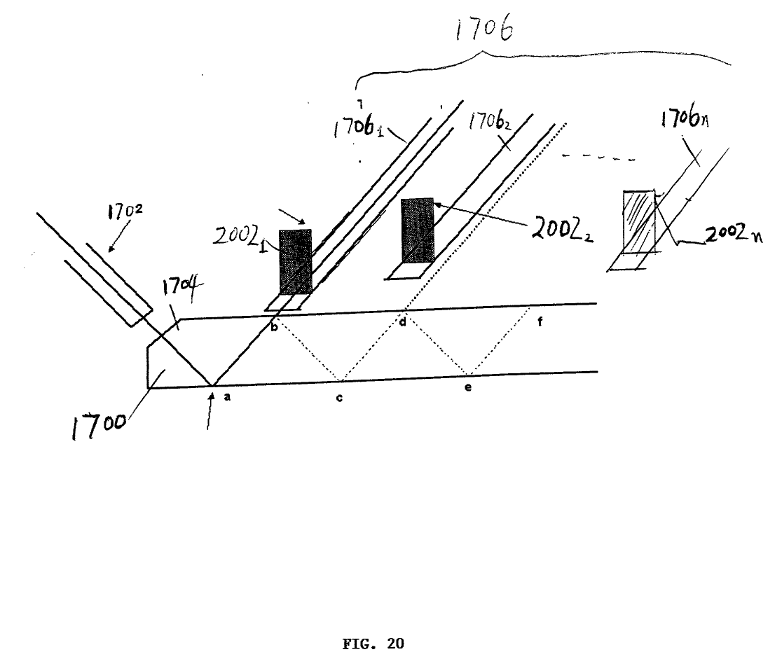

FIG. 20 illustrates an alternative embodiment to bring the outgoing fibers 1706 into proximity of the desired points b, d, f, etc. by using a plurality of piezoelectric driver 2002₁, 2002₂, . . . , 2002ₙ to move the output fibers 1706₁, 1706₂, . . . , 1706ₙ, in a direction perpendicular to the external surface of the quartz device 1700, instead of moving each of the fibers 1706 along the direction of their axes. In FIG. 20, the piezoelectric driver 2002₁ is activated to move the fiber 1706₁ vertically towards the proximity of point b so that the signal coming from the input fiber 1702 is coupled to the user 1.

It should be noted that in FIGS. 18, 19 and 20, the implementation of coupling the input radiation into the user fibers 1706₁, 1706₂, . . . 1706ₙ, are carried out through moving the output fibers from a non-coupling position into a coupling position within a coupling distance of desired points on the external surface of the quartz device 1700. Therefore, the control signal E_{c} 114, shown in FIG. 1, which may command the electric voltage applied to the piezoelectric drivers mounted on each of the output optical fibers, can be in binary form. Such binary control means substantially reduces the hardware cost in implementing the routing process and the possibility of errors.

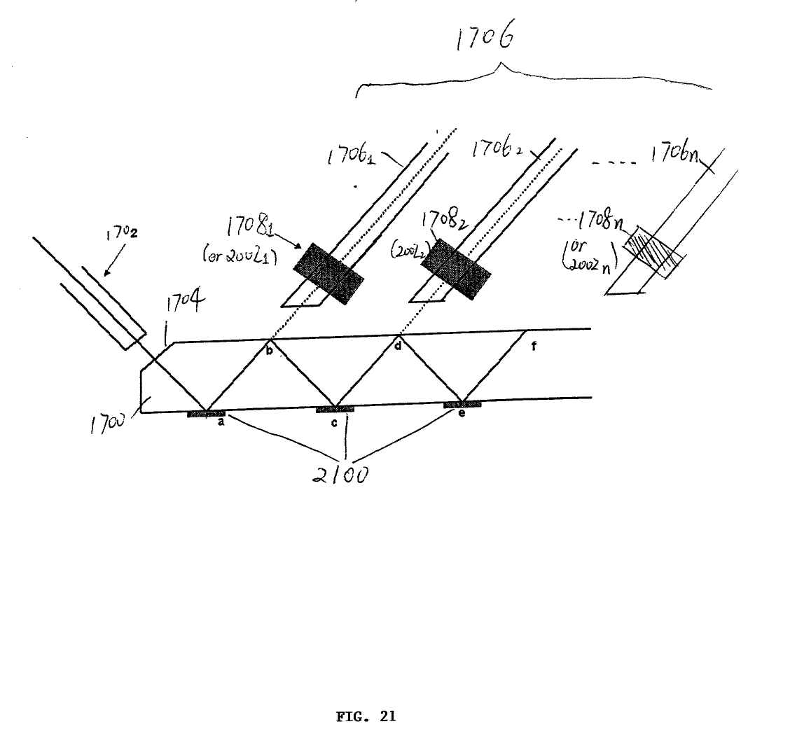

FIG. 21 further shows the use of Fresnel refocusing reflectors 2100 for confocal relaying of the input optical radiation back and forth between the quartz device 1700 surfaces at points of a, c, e, etc. Reflections at points a, c, e, etc., can be made so that there is a continuous refocusing of the radiation in a confocal manner by having these points ground to give a focusing reflection. FIG. 21 shows an alternative method to maintain a continuous refocusing of the radiation by using an externally deposited Fresnel lens 2100. The continuous refocusing of the radiation maintains the density of the optical signals and prevents cross-talk among different optical channels.

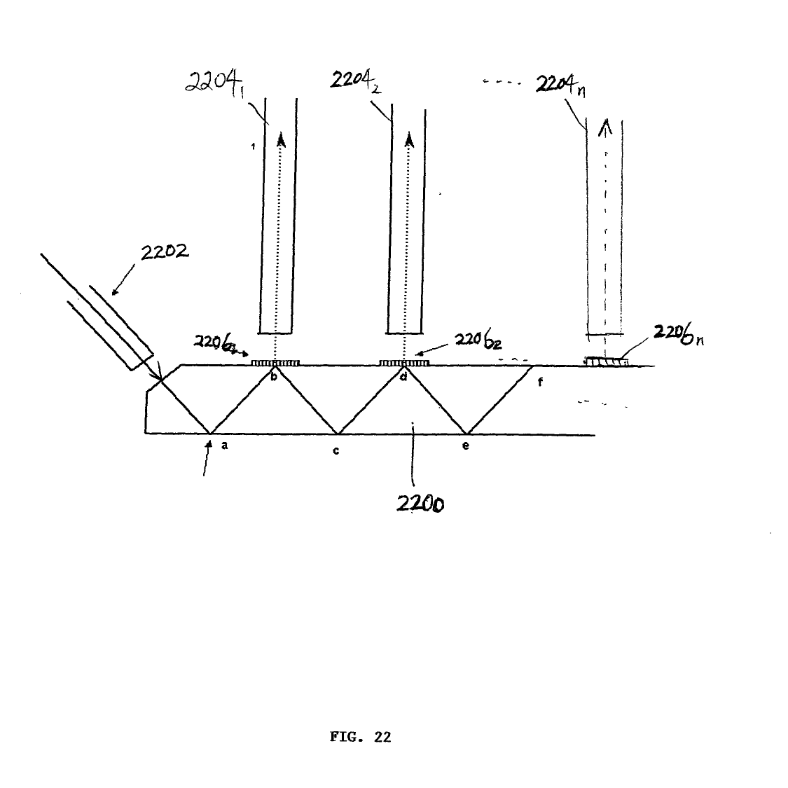

FIG. 22 provides for another embodiment of the present invention for coupling the input/output optical wavelength to a specified output fiber by an electrically switchable grating. The optical router includes a quartz device 2200, which is made of solid-state medium such as high quality quartz or alternatively made of any other low loss optical material at the wavelengths of interest. On the external surface of the quartz device 2200, there are deposited the polymer gratings 2206₁, 2206₂, . . . , 2206ₙ. The polymer gratings can be switched on and off by applying an electrical field. The electrical field is not shown in FIG. 22 where none of the gratings are activated. Output optical fibers 2204₁, 2204₂, . . . , 2204ₙ are positioned to be perpendicular to the external surface of the quartz device 2200 and the surface of the corresponding polymer gratings 2206₁, 2206₂, . . . , and 2206ₙ as shown in FIG. 22. The optical signals received from fiber 2202 bounces back and forth between the surfaces of the quartz device 2200, at point a, b, c, d, etc., when the electrical field is not applied to the polymer gratings. With no electrical field applied to the polymer gratings, the light is not deflected by the deposited polymer gratings.

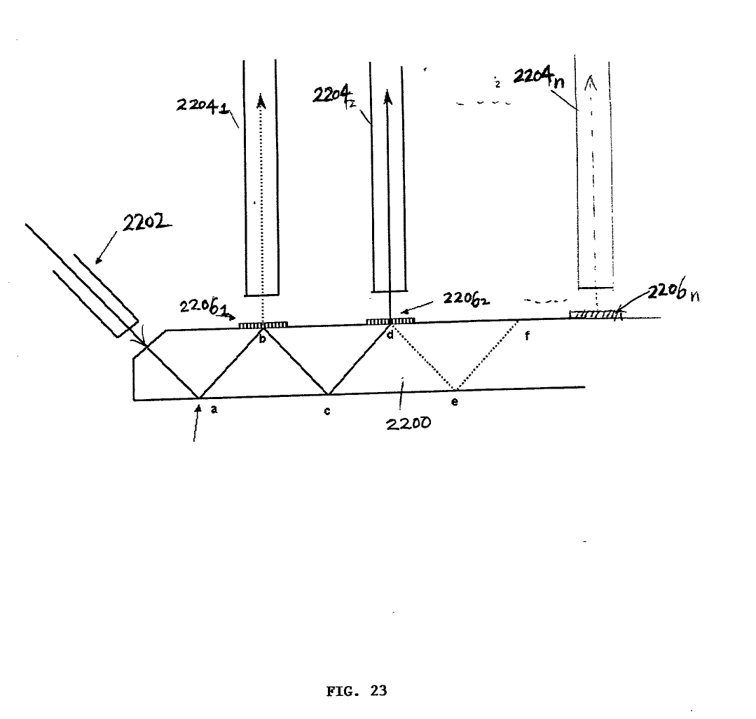

As shown in FIG. 23, when an electrical field is applied to the grating 2206₂, the light is diffracted up into the fiber 2204₂. As a result, the input optical signals can be switched to the user 2. In addition, the switching mechanism using the polymer grating shown in FIG. 22 and FIG. 23 is bi-directional. The returning wavelength is diffracted back into the quartz device 2200 after the electrical field is activated and then relays reversely to the originator of the original input signals.

It will be apparent to one of ordinary skill in the art that the switchable gratings can be made of a variety of different materials, e.g., LiNb₂O₃ grating, to achieve the same purpose of coupling the input radiation to the output fibers. Likewise, other conventionally manufactured electro-optic grating may be used in the embodiment as shown in FIG. 22 and FIG. 23.

The electrical field that is applied to the electro-optic grating is preferably controlled by a digital signal since the operation of the electro-optic only consists of the status of “On” and “Off” of the electrical field. Further, the switching speed of this embodiment of the present invention is very fast because it is in essence electrooptic in operation.

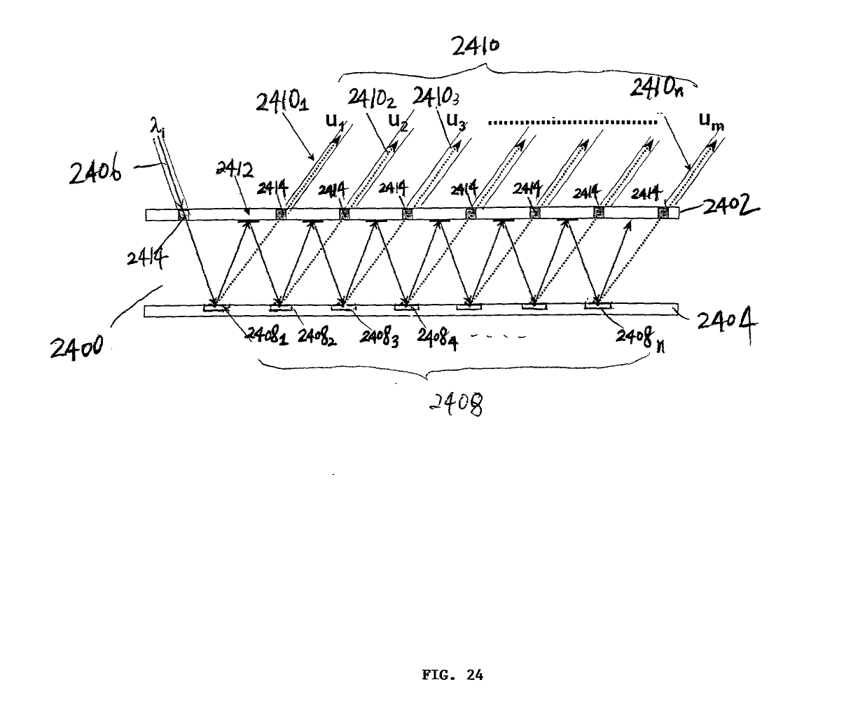

FIG. 24 illustrates another embodiment of the optical router in accordance with the present invention to switch any input channel λᵢ to any of desired users. FIG. 24 shows a two dimensional array of micro-mechanical mirror assembly 2400. The top array of mirrors 2402 is placed in parallel to the bottom array of the mirrors 2404. Similar to the mirrors described above, each of the mirrors 2412 on the top array of mirrors 2402 has high reflectivity and is capable of reflecting any incoming light back to the mirrors located on the bottom array of the mirrors. The output optical fibers 2410₁, 2410₂, . . . , 2410ₙ, collectively referred to as 2410, are respectively connected to the user u₁, u₂, . . . , uₙ and connected to the each of the openings 2414 on the top array of mirrors 2402. The openings 2414 permit the light to pass through to enter the output fibers 2410₁, 2410₂, . . . , 2410ₙ without loss.

On the array of mirrors 2404, there are a plurality of mirrors with electro-optic gratings 2408₁, 2408₂, . . . , 2408ₙ, collectively referred to 2408. The electro-optic gratings of the mirrors are capable of deflecting the incoming light when an electrical field is inserted upon the gratings. As shown in FIG. 24, an input optical channel representing a wavelength λᵢ enters the mirror assembly 2400 through the optical fiber 2406. Normally, when the electrical field is not activated upon the mirrors 2408, the input optical channel is reflected to top array of mirrors 2402 and then bounces back to next mirror on the array 2404. The result is that the input optical channel is unable to enter the output optical fibers 2410. When an electrical field is activated, the gratings on the mirrors 2408 enable the incoming light to be deflected to a direction different from the original reflection direction, which is shown in the dashed line in the FIG. 24. In the operation of the mirror assembly 2400, under the control of the signal E_{c} 114, one of the mirrors 2408 can deflect the input optical signals into a desired output optical fiber. The advantage of this embodiment is that none of the mirrors on the array of mirrors 2402 and 2404 needs to be switched to different physical position in order to transmit the optical signals to the desired output fiber, i.e., the mirrors 2408 do not move. Instead the angle at which an incoming signal is reflected is dependent upon the electric field applied to the mirrors 2408. Further, the electrical field which changes the electro-optic features of the mirrors 2408 only needs to be controlled by a binary signal because the status of “ON” and “OFF” of the electrical field is sufficient to determine whether a mirror on the array 2404 should deflect the input light or not.

While the invention has been particularly shown and described with reference to a preferred embodiment and several alternate embodiments, it will be understood by persons skilled in the relevant art that various changes in form and details can be made therein without departing from the spirit and scope of the invention.

What is claimed is:

1. An optical routing system for switching a plurality of input optical channels to a plurality of recipients, comprising:
a switching device, the switching device including a plurality of micromechanical units and means for changing the angle of reflection occurring on a predetermined micro-mechanical unit to one of two positions in response to a binary control signal in order to switch one of the plurality of the input optical channels to any one of the plurality of the recipients.
